(19) United States
(12) Patent Application Publication
(10) Pub. No.: US 2021/0206071 A1
(43) Pub. Date: Jul. 8, 2021

(54) BUILD UNITS

(71) Applicant: HEWLETT-PACKARD DEVELOPMENT COMPANY, L.P., Spring, TX (US)

(72) Inventors: Tait A. REGNIER, Vancouver, WA (US); Mark GROENENBOOM, Sumner, WA (US); Robert Lawrence WINBURNE, Vancouver, WA (US); Randall WEST, Vancouver, WA (US); Joshua SCHMALE, Vancouver, WA (US)

(73) Assignee: HEWLETT-PACKARD DEVELOPMENT COMPANY, L.P., Houston, TX (US)

(21) Appl. No.: 16/075,597

(22) PCT Filed: Jul. 26, 2017
(86) PCT No.: PCT/US2017/043878

§ 371 Date: Aug. 4, 2018

(51) Int. Cl. B29C 64/245; B29C 64/255

(52) U.S. Cl. CPC B29C 64/245; B33Y 30/00; B29C 64/255

(57) ABSTRACT

A build unit may include a build chamber, at least two datum apertures defined in at least two opposite sides of the build unit, and at least two alignment posts that seat within the datum apertures to couple the lift system to the build chamber, and to align the lift system in a first coordinate direction relative to the build chamber.

### BACKGROUND

Additive manufacturing systems that generate three-dimensional objects on a layer-by-layer basis provide a convenient method for producing three-dimensional objects. Examples of additive manufacturing systems include three-dimensional printing systems. The quality of objects produced by additive manufacturing systems may vary widely based on the type of additive manufacturing technology used.

### BRIEF DESCRIPTION OF THE DRAWINGS

The accompanying drawings illustrate various examples of the principles described herein and are part of the specification. The illustrated examples are given merely for illustration, and do not limit the scope of the claims.

FIG. 1 is a block diagram of a build unit, according to an example of the principles described herein.

FIG. 2 is a block diagram of a three-dimensional (3D) printing device, according to an example of the principles described herein.

FIG. 3 is an isometric view of a build chamber of a build unit, according to an example of the principles described herein.

FIG. 4 is an isometric view of a build unit with a build platform in a raised position, according to an example of the principles described herein.

FIG. 5 is an isometric view of the build unit of FIG. 4 with a build platform in a lowered position, according to an example of the principles described herein.

FIG. 6 is an isometric view of a lift system of the build unit of FIG. 4, according to an example of the principles described herein.

FIG. 7 is a flowchart depicting a method of aligning a build unit, according to an example of the principles described herein.

FIG. 8 is a flowchart depicting a method of aligning a build unit, according to another example of the principles described herein.

Throughout the drawings, identical reference numbers designate similar, but not necessarily identical, elements. The figures are not necessarily to scale, and the size of some parts may be exaggerated to more clearly illustrate the example shown. Moreover, the drawings provide examples and/or implementations consistent with the description; however, the description is not limited to the examples and/or implementations provided in the drawings.

### DETAILED DESCRIPTION

Three-dimensional (3D) printing may include any number of processes that may be grouped generally into subtractive and additive processes. One type of additive 3D printing technique is a build material and thermal fusing agent based technique in which a thin layer of, for example, polymer build material is spread on a build platform to form a first layer of build material on the build platform. An ejection device, such as an inkjet print head, is then used to print a fusing agent over portions of the build material corresponding to a thin layer of the 3D object to be formed. The build platform of build material is exposed to a light or a heat source at least at the locations wherein the fusing agent has been deposited. The fusing agent absorbs more energy than the unprinted build material. The absorbed thermal energy causes the printed portions of the build material to heat up, melt, and coalesce, or fuse. This forms a solid portion that defines a layer of the 3D object. After that layer is formed, a new thin layer of build material is spread over the build platform and the previous layer, and the process is repeated to form additional layers until a complete 3D object is printed.

To absorb and convert the light energy to thermal energy, near-infrared dyes can be used in the fusing agent. These near-infrared dyes can absorb light wavelengths in the range of about 800 nm to 1400 nm and convert the absorbed light energy to thermal energy. When used with a light source that emits a wavelength in this range and a polymer build material that has a low absorbance in this range, the near-infrared dye causes the printed portions of the polymer build material to melt and coalesce without melting the remaining polymer build material on which no fusing agent has been printed. In other examples, carbon black may be used as a fusing agent. Eventually, any unfused build material may be removed in order to reveal the 3D object created in the process.

In some instances, the alignment of the build platform may change with respect to the material dispensing devices and other elements within the 3D printing device. This misalignment leads to the deposition of layers that are not aligned in a manner according to an intended shape of the 3D object being printed. In order to properly align successive layers of build material on the build platform, the build platform may be aligned using a number of alignment devices and techniques.

In some examples, alignment of a lift system may include high precision mounting and alignment to a chassis of the 3D printing device and the build chamber. Precision platform lift systems may often use expensive machined components to mount and align them while maintaining the minimum tolerance loop. These systems also tend to be hard to install and align because of the expensive parts and tight tolerances. Further, maintaining the alignment of the lift system to the build chamber may be a laborious task since realignment uses the same time-consuming and expensive methods and devices.

Examples described herein provide a build unit. The build unit may include a build chamber, at least two datum apertures defined in at least two opposite sides of the build unit, and at least two alignment posts that seat within the datum apertures to couple the lift system to the build chamber, and to align the lift system in a first coordinate direction relative to the build chamber. At least two sides of the build chamber extend below a bottom of a lowest level of a build platform. The at least two datum apertures are defined in at least two opposite sides of the build chamber. The build unit may also include at least one locking fastener coupling the lift system to the build chamber to lock the alignment in the first coordinate direction.

The build unit may also include an alignment gasket coupled to a build platform of the lift system. The alignment gasket contacts an interior of the build chamber to align the lift system relative to the build chamber as the lift system moves the build platform through the build chamber. At least one vee bearing may also be included to align the lift system in a second coordinate direction relative to the build chamber. The build unit may also include at least one guiding slot defined in the sides of the build chamber. The datum apertures defined within the sides of the build chamber are a terminal of the guiding slots. Further, the datum apertures are dimensioned to seat the alignment posts such that the alignment posts cannot move within the datum apertures.

The build unit may also include a motor, a set of gears rotatably coupled to the motor, and a screw driveshaft rotatably coupled to the gears. Activation of the motor causes the gears to rotate the screw driveshaft to move a build platform coupled to the guide shafts in a third coordinate direction.

Examples described herein also provide a three-dimensional (3D) printing device. The 3D printing device may include a build chamber. The build chamber includes at least two sides extending below a bottom of a lowest level of a moveable build platform, and at least two mounting points defined in at least two opposite sides of the build chamber. The build chamber also includes a lift system. The lift system includes at least two alignment posts coupled to the lift system that seat within the mounting points to align the lift system in a first coordinate direction relative to the build chamber. The mounting points include at least one guiding slot defined in the sides of the build chamber, and a number of datum apertures defined within the sides of the build chamber as a terminal of the guiding slot. The datum apertures are dimensioned to seat the alignment posts such that the alignment posts cannot move within the datum apertures.

The 3D printing device may also include at least one locking fastener to lock the lift system in an aligned orientation relative to the build chamber. Further, the 3D printing device may also include an alignment gasket coupled to a build platform of the lift system to align the lift system relative to the build chamber as the lift system moves the build platform through the build chamber, and at least one guide shaft bearing assembly coupled to at least one bracket of the lift system and at least one guide shaft via at least one vee bearing to align the lift system in a second coordinate direction relative to the build chamber in response to the alignment gasket aligning the build platform as the build platform moves through the build chamber.

Examples described herein also provide a method of aligning a build unit. The method may include coupling a lift system to a build chamber using at least one alignment post coupled to the lift system that seat within a corresponding number of datum apertures defined in at least two opposite sides of the build chamber. The coupling of the lift system to the build chamber aligns the lift system in a first coordinate direction relative to the build chamber. The method also includes aligning the lift system in a second coordinate direction relative to the build chamber using at least one guide shaft bearing assembly coupled to at least one bracket of the lift system. An alignment gasket coupled to a build platform of the lift system aligns the lift system relative to the build chamber as the lift system moves the build platform through the build chamber.

The method may further include locking an alignment in the first coordinate direction using at least one locking fastener coupling the lift system to the build chamber. The guide shaft bearing assembly includes a first guide shaft bearing assembly coupled to a first guide shaft. The first guide shaft assembly is anchored to the bracket. The guide shaft bearing assembly also includes a second guide shaft assembly coupled to a second guide shaft. The second guide shaft assembly being floatingly coupled to the bracket to allow for the second guide shaft assembly to float in the first coordinate direction.

The method may further include realigning the lift system. Realignment may include positioning a build platform of the lift system to an alignment height, unfastening at least one clamping fastener of a first guide shaft bearing assembly to permit the lift system to pivot, with an alignment gasket coupled to the build platform of the lift system, aligning the lift system relative to the build chamber, and fastening the clamping fasteners of the first guide shaft bearing assembly to statically couple the first guide shaft bearing assembly to the lift system.

In the following description, for purposes of explanation, numerous specific details are set forth in order to provide a thorough understanding of the present systems and methods. It will be apparent, however, to one skilled in the art that the present apparatus, systems, and methods may be practiced without these specific details. Reference in the specification to “an example” or similar language means that a particular feature, structure, or characteristic described in connection with that example is included as described, but may or may not be included in other examples.

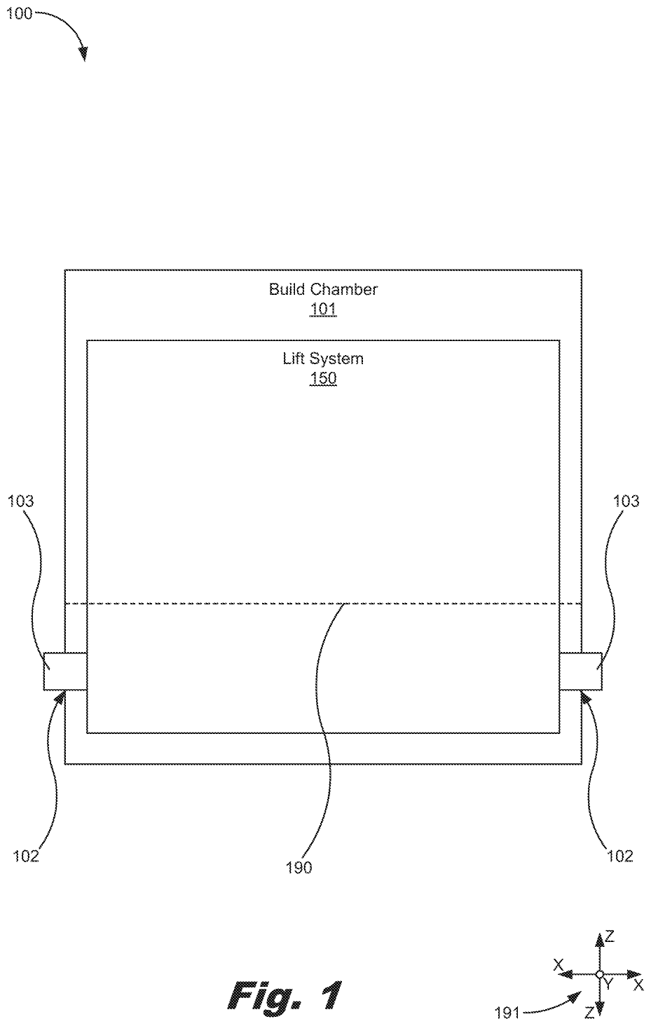

Turning now to the figures, FIG. 1 is a block diagram of a build unit (100), according to an example of the principles described herein. The build unit (100) may be incorporated into a three-dimensional (3D) printing device, and is used to form a printed 3D object by lowering a build platform of the build unit (100) iteratively as successive layers of build material are placed on the build platform and other layers of build material. The build unit (100) may include a lift system (150) that is coupled to the build platform to move the build platform up and down within a build chamber (101). The build chamber (101) is a container surrounding the lift system (150) used to contain a 3D printed object as it is printed, and is sometimes referred to as a “bucket.”

The build chamber (101) and the lift system (150) are coupled using at least two alignment posts (103) that seat within a number of datum apertures (102) defined in at least two opposite sides of the build unit. In one example, the datum apertures (102) are defined within two opposite sides of the build chamber (101). In this example, the alignment posts (103) may be coupled to the lift system (150), and the lift system (150) may be coupled to the build chamber (101) by seating the alignment posts (103) of the lift system (150) into the datum apertures (102) defined in the sides of the build chamber (101). In another example, however, the datum apertures (102) may be defined in two opposite sides of the lift system (150), and the build chamber (101) may be coupled to the lift system (150) by seating the alignment posts (103) of the build chamber (101) into the datum apertures (102) defined in the sides of the lift system (150). Thus, even though the figures depict the datum apertures (102) being defined in the build chamber (101) and the alignment posts (103) being part of the lift system (150), either example may apply, and the engagement and alignment between the build chamber (101) and the lift system (150) is provided by the interface of the alignment posts (103) into the datum apertures (102).

In one example, the interface between the alignment posts (103) into the datum apertures (102) is located below a vertical level (190) of the build unit (100) that defines a lowest drop level of a build platform of the build unit (100). In this manner, at least two sides of the build chamber (101) extend below a bottom of a lowest level of a build platform. In one example, the at least two datum apertures (102) are defined in at least two opposite sides of the build chamber (101), and at least one locking fastener may be used to couple the lift system (150) to the build chamber (101) to lock the alignment between the lift system (150) to the build chamber (101) in a first coordinate direction. In the example of FIG. 1, the locking fastener may lock the alignment between the lift system (150) to the build chamber (101) in the y-direction as indicated by the coordinate indicator (191). Alignment along the y-axis is described herein in more detail.

In the examples described herein, the lift system (150) and the build chamber (101) may be separated from one another. However, in another example, the lift system (150) is coupled to the build chamber (101), but is allowed to be adjusted relative to the build chamber (101). Further, in one example, the build unit (101) is removable from or may be separated from a printing device in which the build unit (100) is incorporated. However, in another example, the build unit (100) may be fixed within the printing device. In this example, the lift system (150) may be removable from the build chamber (101).

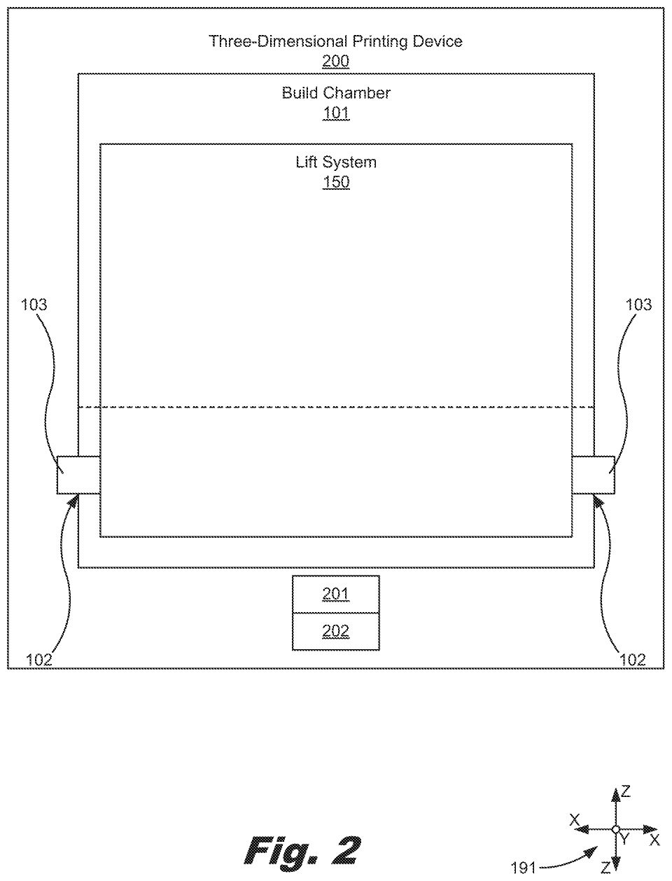

FIG. 2 is a block diagram of a three-dimensional (3D) printing device (200), according to an example of the principles described herein. Similarly-numbered elements included in FIG. 1 and described in connection with FIG. 1 designate similar elements within FIG. 2. The 3D printing device (200) may be any device used to create a 3D object in which layers of material are formed under computer control to create the object. The 3D printing device (200) of FIG. 2 includes the build chamber (101), lift system (150), datum apertures (102), and alignment posts (103) as described in connection with FIG. 1

The 3D printing device (200) may include a processing device (201) and a data storage device (202). The processing device (201) may include hardware architecture to retrieve executable code from the data storage device (202) and execute the executable code. The executable code may, when executed by the processing device (201), cause the processing device (201) to implement at least the functionality of retrieving digital model data from a 3D model or another electronic data file such as an Additive Manufacturing File (AMF) from the data storage device (202), and use that data to instruct a number of material deposition devices such as printheads to deposit build material onto a build platform of the build unit (100) in a digitally addressed manner. The executable code may, when executed by the processing device (201), cause the processing device (201) to implement at least the functionality of moving the lift system (150) within the build chamber (101) during printing of the 3D object, according to the methods of the present specification described herein. The processing device (201) may move the lift system (150) and its build platform (151) vertically as more build material is deposited and cured on the build platform (151), and may do so, in one example, in an incremental manner. The processing device (201) may also move the lift system (150) during an alignment process to align the lift system (150) relative to the build chamber (101), and during any re-alignment processes to ensure that the layers of build materials deposited by the printheads of the 3D printing device (200) are aligned according to the digital model data, according to the methods of the present specification described herein. In the course of executing code, the processor (101) may receive input from and provide output to a number of the remaining hardware units.

The data storage device (202) may store data such as executable program code that is executed by the processing device (201). As is described herein, the data storage device (202) may store computer code representing a number of applications that the processing device (201) executes to implement at least the functionality described herein. The data storage device (202) may include various types of memory modules, including volatile and nonvolatile memory. For example, the data storage device (202) of the present example may include Random Access Memory (RAM), Read Only Memory (ROM), and Hard Disk Drive (HDD) memory. Many other types of memory may also be utilized, and the present specification contemplates the use of many varying type(s) of memory in the data storage device (202) as may suit a particular application of the principles described herein. In certain examples, different types of memory in the data storage device (202) may be used for different data storage needs. For example, in certain examples the processing device (201) may boot from Read Only Memory (ROM), maintain nonvolatile storage in the Hard Disk Drive (HDD) memory, and execute program code stored in Random Access Memory (RAM).

The data storage device (202) may include a computer readable medium, a computer readable storage medium, or a non-transitory computer readable medium, among others. For example, the data storage device (202) may be, but not limited to, an electronic, magnetic, optical, electromagnetic, infrared, or semiconductor system, apparatus, or device, or any suitable combination of the foregoing. More specific examples of the computer readable storage medium may include, for example, the following: an electrical connection having a number of wires, a portable computer diskette, a hard disk, a random-access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a computer readable storage medium may be any tangible medium that can contain, or store computer usable program code for use by or in connection with an instruction execution system, apparatus, or device. In another example, a computer readable storage medium may be any non-transitory medium that can contain, or store a program for use by or in connection with an instruction execution system, apparatus, or device.

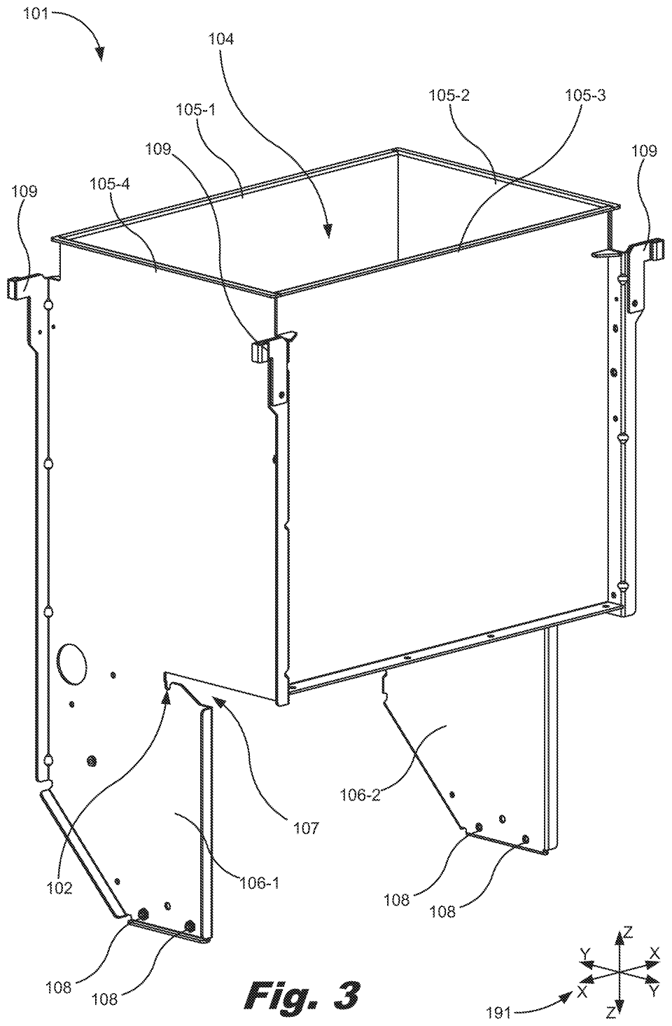

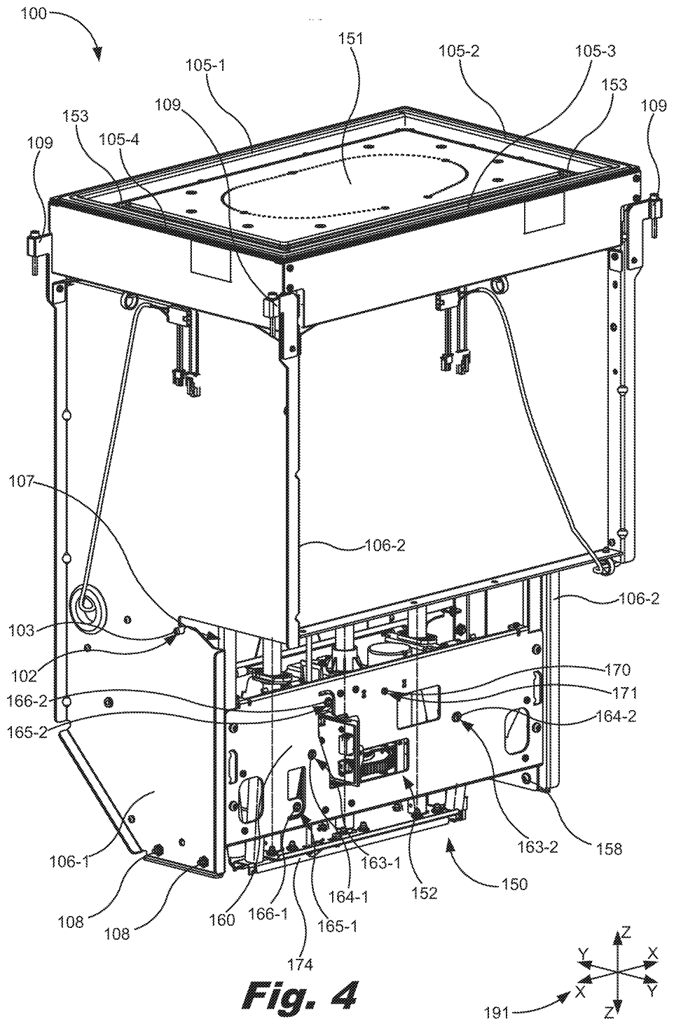

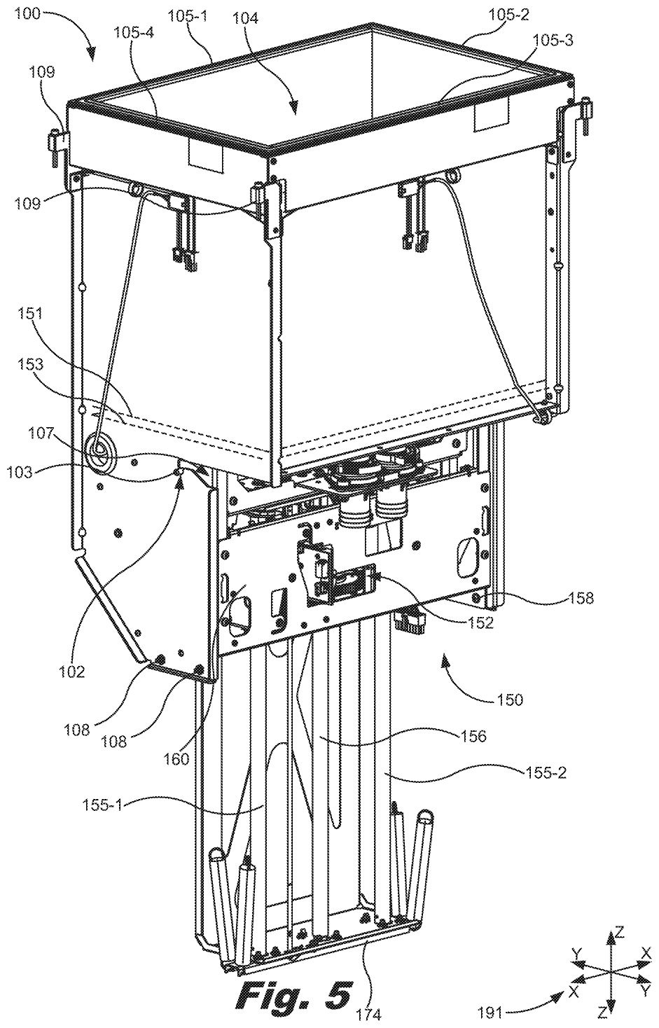

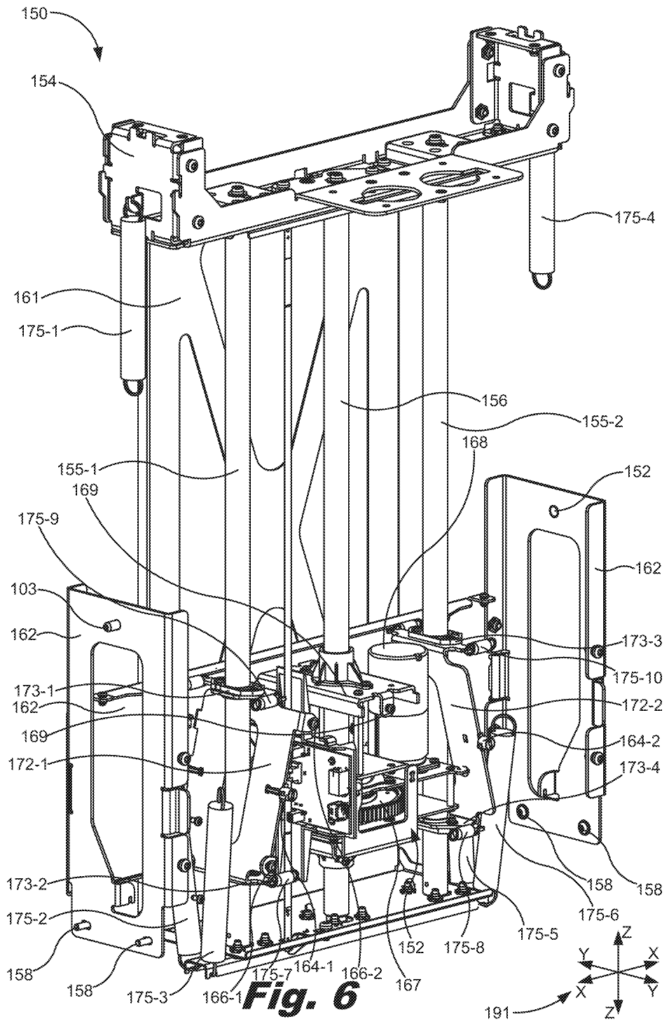

FIGS. 3 through 6 depicting various elements of the build chamber (101) and lift system (150) will now be described together. FIG. 3 is an isometric view of a build chamber (101) of a build unit (100), according to an example of the principles described herein. Further, FIG. 4 is an isometric view of a build unit (100) with a build platform (151) in a raised position, according to an example of the principles described herein. Still further, FIG. 5 is an isometric view of the build unit (100) of FIG. 4 with the build platform (151) in a lowered position, according to an example of the principles described herein. Yet further, FIG. 6 is an isometric view of a lift system (150) of the build unit (100) of FIG. 4, according to an example of the principles described herein.

Beginning with the build chamber (101), an interior space (104) may be formed using four walls (105-1, 105-2, 105-3, 105-4, collectively referred to herein as 105) with walls (105-1, 105-3) being the back and front walls, respectively, and walls (105-2, 105-4) being the side walls. The walls (105) are formed to be perpendicular to neighboring walls (105). Further, the side walls (105-2, 105-4) include wail extensions (106-1, 106-2) that extend from the side walls (105-2, 105-4) and below the bottom of the front and back walls (105-1, 105-3).

The wall extensions (106-1, 106-2) include a number of elements used to align the lift system (150) within the build chamber (101), and couple the lift system (150) and the build chamber (101) together in the aligned state. One of these elements includes datum apertures (102) defined in each of the wall extensions (106-1, 106-2). The datum apertures (102) are sized to interface with a corresponding number of alignment posts (103) coupled to the lift system (150) as depicted in, for example, FIGS. 4, 5, and 6.

Each wall extension (106-1, 106-2) includes a guiding slot (107) defined therein with the datum apertures (102) being the terminus of each guiding slot (107). The guiding slots (107) are used as pathways through which the alignment posts (103) of the lift system (150) are guided through in order to seat within the datum apertures (102).

The guiding slots (107) assist a user in coupling the lift system (150) to the build chamber (101) by guiding the alignment posts (103) into a proper seated position within the datum apertures (102) making the coupling of the lift system (150) to the build chamber (101) easier. Further, because the wall extension (106-1, 106-2) of the side walls (105-2, 105-4) both hold the lift system (150) and are used to align the lift system (150) to the build chamber (101), and because the build chamber is coupled to the 3D printing device (200) via the side walls (105-2, 105-4), the lowest possible tolerance loop from the 3D printing device (200) to the build platform (151) of the lift system (150) is obtained.

With the alignment posts (103) seated in the datum apertures (102), the lift system (150) is fully supported by the build chamber (101) and is ready for an alignment procedure before being locked into place. After the alignment procedure is performed, the mutually aligned build chamber (101) and lift system (150) may be coupled in this aligned state using four locking fasteners (108), two on each wall extension (106-1, 106-2), that mate with corresponding locking barrel nuts (158) located on the lift system (150) as depicted in FIG. 6. The locking fasteners (108) are engaged and fasten or lock the build chamber (101) to the lift system (150) after an alignment process has occurred in order to lock the lift system (150) in an aligned orientation relative to the build chamber (101). The locking fasteners (108) lock the lift system (150) in an aligned orientation relative to the build chamber (101) about the x-axis such that the build platform (151) cannot move in the y-direction. In this manner, the lift system (150) may be aligned relative to the build chamber (101) in the y-direction as indicated by the coordinate indicator (191). Any type of fastener may be used to couple the build chamber (101) to the lift system (150).

The manner in which the lift system (150) is aligned relative to the build chamber (101) in the y-direction, and coupled in that state provides for a quick and repeatable installation of the lift system (150) onto the build chamber (101) and allows for a simple alignment procedure of the lift system (150). The lift system (150), in this manner, is able to be supported by the build chamber (101) once seated into place, and the locking fasteners (108) do not have to be engaged with the locking barrel nuts (158) until the alignment procedure is completed. Further, the alignment in the y-direction between the lift system (150) and the build chamber (101) is accomplished at a low cost where all of the elements are made of sheet metal using low-cost manufacturing processes and low-cost fasteners to couple these elements to one another. Further, the datum apertures (102), alignment posts (103), and guiding slots (107) provide a one-person installation of the lift system (150) into the build chamber (101), while, at the same time, providing the alignment between the lift system (150) and the build chamber (101) with a minimized tolerance loop between the lift system (150) and the build chamber (101).

The build chamber (101) may also include a number of chassis hangers (109) that are used to couple the build chamber (101) to a chassis of the 3D printing device (200). Using the alignment of the lift system (150) to the build chamber (101) described herein, the chassis hangers (109) assist in aligning the build unit (100) and its aligned lift system (150) and build chamber (101) to a chasse of the 3D printing device,

In FIG. 4, the build chamber (101) and the lift system (150) are depicted in a coupled state with the build platform (151) at a highest level within the build chamber (101). It is in this state where the 3D printing device (200) begins its printing process by depositing build material and incrementally moving down in the z-direction as successive layers of material are deposited. The build unit (100) raises and lowers the build platform within the build chamber (101). At the start of a build of a 3D object, the build platform (151) is positioned in the up, or home position as depicted in FIG. 4, a build material such as plastic powders, metal powders, ceramic powders, or other build materials is dispensed on the build platform (151) in layers approximately 0.08 mm or 0.10 mm thick. The build material is then fused to form a solid layer. During a build, a static drive system (152) within the lift system (150) indexes the lift system (150) down with the build platform (151). The drive system (152) may be engineered to index accurately to within a few micrometers, In order to ensure a quality output in the 3D object as built, the build platform (151) tracks consistently and orthogonal to a carriage axis indicated by coordinate direction Z of the coordinate indicator (191). To assist in in the alignment and maintaining of alignment in the build unit (100), an alignment gasket (153) or other gasket may be placed around the build platform (151). As is described in more detail herein, in order to optimize the alignment of the lift system (150) relative to the build chamber (101) of the build unit (100), the X and Y position of the build platform (151) is aligned using pivoting motion provided by the datum aperture (102), alignment posts (103), and other alignment devices, as well as the biasing force created by the alignment gasket (153) at a chosen height of the build platform (151) in the build chamber (101). Once aligned, the alignment devices are fixed in place and the build platform (151) tracks consistently through the build chamber (101) as it is moved up and down using the lift system (150).

Many elements of the lift system (150) as depicted in FIG. 4 are covered by a front chassis (160). The front chassis (160) serves as a mounting structure for at least one alignment element within the lift system (150). As depicted in FIGS. 5 and 6, the lift system also includes a rear brace (161) and a rear chassis (162) that includes a back and two side walls that couple to the front chassis (160). The front chassis (160) may include apertures into which alignment elements within the lift system (150) are anchored, For example, the front chassis (160) may include first and second pivot apertures (163-1, 163-2) into which corresponding brace pivot pins (164-1, 164-2) are seated and anchored to the framework formed by the front chassis (160) and the rear chassis (162). The brace pivot pins (164-1, 164-2) are coupled to approximately the middle of the bearing plates (172-1, 172-2) and include pivoting elements in the front and back of the bearing plates (172-1, 172-2) so they can couple to the front chassis (160) and the rear chassis (162), respectively. The front chassis (160) may also include first and second brace pin apertures (165-1, 165-2) into which corresponding brace locking pins (166-1, 166-2) are seated and anchored to the framework formed by the front chassis (160) and the rear chassis (162), The brace pivot pins (164-1, 164-2) and brace locking pins (166-1, 166-2) are described in more detail herein.

FIG. 5 depicts the lift system (150) coupled to the build chamber (101) and in a state where the build platform (151) is located at the lowest point within the build chamber (101). FIG. 6 depicts the lift system (150) separated from the build chamber (101) and exposing a number of additional elements that assist the lift system (150) in lowering and raising the build platform (151) and aligning the lift system (150) relative to the build chamber (101).

The build platform (151) is removed from the lift system (150) of FIG. 6 to expose a platform chassis (154). The build platform (151) depicted in, for example, FIG. 4, may be coupled to the platform chassis (154). Two guide shafts (155-1, 155-2) and a screw driveshaft (156) couple the platform chassis (154) to the remainder of the lift system (150). The screw driveshaft (156) may include threads that engage a gear set (167) mechanically coupled to a motor (168) that drives the gears. Actuation of the motor (168) results in the driving of the screw driveshaft (156) through a drive shaft mounting plate (169) to move the platform chassis (154) and build platform (151) up and down during various printing and aligning processes. The drive shaft mounting plate (169) includes a mounting plate pin (170) that engages with a mounting plate aperture (171) defined in the front chassis (160) and may include a second set of mounting plate pin (170) and mounting plate aperture (171) on the back side to mount the drive shaft mounting plate (169) to a rear panel of the rear chassis (162).

The guide shafts (155-1, 155-2) assist in supporting the build platform (151) and are used to align the build platform (151) of the lift system (150) within the build chamber (101). Each guide shaft (155-1, 155-2) includes a bearing plate (172-1, 172-2). The bearing plates (172-1, 172-2) are coupled to the guide shafts (155-1, 155-2) by a number of bearings (173-1, 173-2, 173-3, 173-4) located at the top and bottom of each bearing plate (172-1, 172-2) and perpendicularly coupled to the guide shafts (155-1, 155-2). In one example, the of bearings (173-1, 173-2, 173-3, 173-4, collectively referred to herein as 173) are vee bearings. Vee bearings are any linear motion bearing and, in one example, may include external and internal 90-degree vee angles. As may occur with many bearing types, the bearings (173) may wear after use, and wearing of the bearings may alter the alignment of the build platform (151) over a period of use. Thus, an alignment process to both originally align the build platform (151) of the lift system (150) with the build chamber (101) and re-align these elements may be performed as described herein to take into account the wearing of the bearings (173). The bearing plates (172-1, 172-2) are pivotally coupled to the front chassis (160) via the pivot pins (164-1, 164-2).

The guide shafts (155-1, 155-2) are coupled to and supported by a base plate (174). Further, the base plate (174) may be coupled to or formed with the rear brace (161). The rear brace (161) is coupled to the platform chassis (154). With this relationship of elements, the build platform (151), the platform chassis (154), the rear brace (161) and the base plate (174) move together in the positive and negative z-direction as the build platform (151) moves up and down within the build chamber (101). During this movement, the guide shafts (155-1, 155-2) move through the bearing plates (172-1, 172-2) and the bearings (173) and the screw driveshaft (156) turns through the drive shaft mounting plate (169). The gear set (167), motor (168), bearing plates (172-1, 172-2), bearings (173), front chassis (160), and rear chassis (162) remain stationary with the build chamber (101).

The brace locking pins (166-1, 166-2) are used to lock the bearing plates (172-1, 172-2), the bearings (173), and the guide shafts (155-1, 155-2) in an aligned orientation relative to the build chamber (101) about the y-axis such that the build platform (151) cannot move in the x-direction. During an alignment procedure, the brace locking pins (166-1, 166-2) are disengaged such that the bearing plates (172-1, 172-2) and bearings (173) are free to move relative to the front chassis (160) and rear chassis (162). In one example, the second pivot aperture (163-2) is dimensioned to allow the corresponding brace pivot pin (164-2) to move in the x-direction within the second pivot aperture (163-2). Because there may be manufacturing variations in the guide shafts (155-1, 155-2) even though the guide shafts (155-1, 155-2) are in a fixed position, the brace pivot pin (164-2) is allowed to float in the x-direction within the second pivot aperture (163-2) to accommodate for these manufacturing variations and correct any misalignment of the build platform (151) that may occur during a build process. Further, the floating of the brace pivot pin (164-2) within the second pivot aperture (163-2) may be used during an alignment process in order to allow the build platform (151) of the lift system (150) to self-align as described herein.

The lift system (150) may also include a number of springs (collectively referred to herein as 175). The springs (175) are depicted as having one end not being coupled to any portion of the build unit (100), and this is done to ensure that other elements may be depicted. However, the uncoupled ends of the springs (175) are, as installed, coupled to hooks located at interior portions of the front chassis (160), the rear chassis (162), the platform chassis (154), and the base plate (174). The springs (175) may include a plurality of lift springs (175-1, 175-2, 175-3, 175-4, 175-5, 175-6) to pull the base plate (174), front chassis (160), and rear chassis (162) vertically toward the platform chassis (154). The lift springs (175-1, 175-2, 175-3, 175-4, 175-5, 175-6) ensure that tension exists on the screw driveshaft (156) so that any lack of tolerance between the screw driveshaft (156) and drive shaft mounting plate (169) does not affect the alignment or the incremental manner in which the build platform (151) moves up and down. The springs (175) may also include a plurality of bearing bias springs (175-7, 175-8, 175-9, 175-10) that create a counterclockwise moment that biases the bearings (173-1, 173-2, 173-3, 173-4) against their respective guide shafts (155-1, 155-2) during an alignment process. Although four bearing bias springs (175-7, 175-8, 175-9, 175-10) are identified in FIG. 6, other bearing bias springs may be coupled to the back sides of the bearing plates (172-1, 172-2).

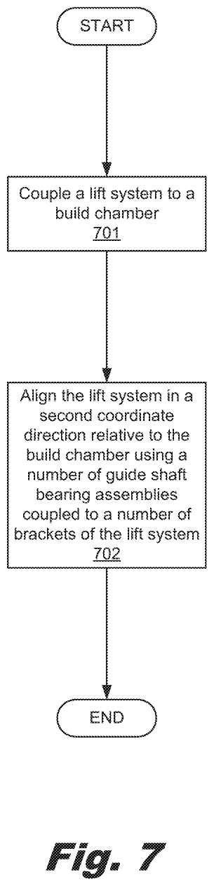

FIG. 7 is a flowchart depicting a method of aligning a build unit, according to an example of the principles described herein. The method of FIG. 7 may begin by coupling (block 701) a lift system (150) to a build chamber (101) using at least one alignment post (103) coupled to the lift system (103) that seat within a corresponding number of datum apertures (102) defined in at least two opposite sides of the build chamber (101). The coupling of the lift system (150) to the build chamber (101) in this manner aligns the lift system (150) in a first coordinate direction relative to the build chamber (101). In one example, this first coordinate direction is the x-coordinate direction as indicated in FIGS. 3 through 6. The method may further include aligning (block 702) the lift system (150) in a second coordinate direction relative to the build chamber (101) using at least one guide shaft bearing assembly coupled to at least one bracket of the lift system (150). The second coordinate direction is the y-coordinate direction as indicated in FIGS. 3 through 6. The guide shaft bearing assembly may include a first guide shaft bearing assembly coupled to a first guide shaft (155-1) where the first guide shaft assembly is anchored to the bracket, and a second guide shaft assembly coupled to a second guide shaft (155-2) where the second guide shaft assembly is floatingly coupled to the bracket to allow for the second guide shaft assembly to float in the first coordinate direction. The guide shaft bearing assemblies may include the guide shafts (155-1, 155-2), bearing plates (172-1, 172-2), bearings (173-1, 173-2, 173-3, 173-4), bearing bias springs (175-7, 175-8. 175-9, 175-10), the brace pivot pins (164-1, 164-2), or combinations thereof. The alignment gasket (153) coupled to the build platform (151) of the lift system (150) aligns the lift system (150) relative to the build chamber (101) as the lift system (150) moves the build platform (151) through the build chamber (101).

The method may further include locking (block 703) an alignment in the first coordinate direction using at least one locking fastener (108) coupling the lift system (150) to the build chamber (101).

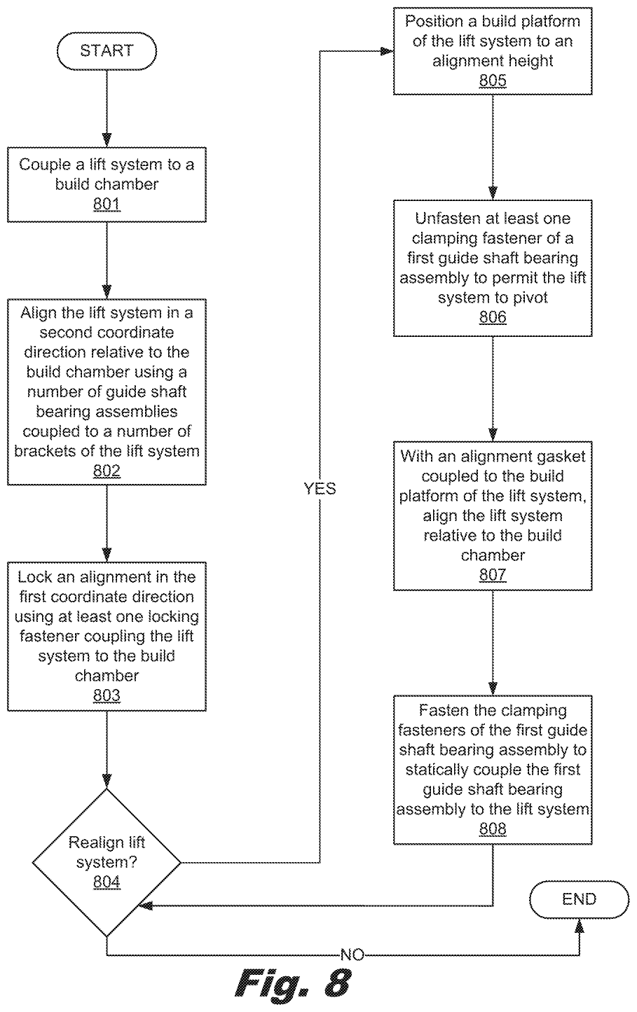

FIG. 8 is a flowchart depicting a method of aligning a build unit (100), according to another example of the principles described herein. The method of FIG. 8 may begin with blocks 801 through 803 which are identical to blocks 701 through 703 of FIG. 7. A determination (block 804) as to whether the lift system (150) should be realigned is made. If it is determined that no realignment is to be made (block 804, determination NO), then the process may terminate. In another example, block 804 may be performed any number of times with the “NO” determination looping back to block 804.

If, however, it is determined that realignment is to be made (block 804, determination YES), then the method may include positioning (block 805) a build platform (151) of the lift system (150) to an alignment height. For example, the build platform (151) may be moved to the top or the bottom of the build chamber (101). In one example, positioning (block 805) of the build platform (151) of the lift system (150) to an alignment height may occur before locking (block 803) an alignment in the first coordinate direction using at least one locking fastener (108) coupling the lift system (150) to the build chamber (101). In this manner, the alignment gasket (153) of the build platform (151) may be used to align the lift system (150) relative to the build chamber (101) in the X and Y directions prior to locking alignment in any direction.

The method may include unfastening (block 806) at least one clamping fastener such as the brace locking pins (166-1, 166-2) of a first guide shaft bearing assembly to permit the lift system (150) to pivot. The lift system (150) may be aligned (block 807) relative to the build chamber (101) using an alignment gasket (153) coupled to the build platform (151) of the lift system (150). The method may continue by fastening (block 808) the clamping fasteners (166-1, 166-2) of the first guide shaft bearing assembly to statically couple the first guide shaft bearing assembly to the lift system (150).

In the context of FIGS. 7 and 8, alignment of the lift system (150) along the x-axis and in the y-direction relative to the build chamber (101) is provided by a pivoting motion of the entire lift system (150) (including those portions of the lift system (150) that are static as well as those portions of the lift system (150) that are dynamic) relative to the build chamber (101). The x-axis, y-direction pivot access is created by the alignment posts (103) coupled to a side panel of the rear chassis (162) of the lift system (150). The alignment posts (103) engage the datum apertures (102) as mating features in the build chamber (101). In one example, the lift system (150) may be installed from the bottom of the build chamber (101) with the build platform (151) being coupled to the platform chassis (154) from the top of the build chamber (101) after the lift system (150) is installed. Because the pivot axis is below the build chamber (101), this creates a long pivot arm to the top surface of the build platform (151), and the resulting motion of the build platform (151) is nearly linear. Thus y-directional build platform (151) alignment is determined by the natural balancing of the front and rear seal forces provided by the alignment gasket (153) acting between the build platform (151) and the build chamber (101). The balance of the seal force provided by the alignment gasket (153) allows the build platform (151) to be aligned in a simple procedure that is described herein. Once the x-axis, y-directional alignment is aligned, the locking fasteners (108) on both the left and right wall extensions (106-1, 106-2) clamp the side panel of the rear chassis (162) and the lift system (150) to the build chamber (101). This completes the x-axis, y-directional alignment of the lift system (150) relative to the build chamber (101).

Alignment about the y-axis or x-directional alignment is accomplished by pivoting the movable, dynamic portion of the lift system (150) including those elements that move relative to the build chamber (101), with the build platform (151) about the left guide shaft bearing assembly. The left guide shaft bearing assembly includes the left guide shaft (155-1), and its associated bearing plate (172-1), bearings (173-1, 173-2), brace locking pins (166-1, 166-2), brace pivot pin (164-1), bearing bias springs (175-7, 175-9), and associated voids and fasteners. The bearings (173-1, 173-2) are mounted to the pivoting bearing plate (172-1), and during assembly and servicing, the bearing assembly is permitted to pivot relative to the static portion of the lift system (150) including, for example, the front chassis (160) and the rear chassis (162). The brace pivot pins (164-1, 164-2) on the bearing plates (172-1, 172-2) engage the front chassis (160) and rear chassis (162), and the left brace pivot pin (164-1) in particular, serves as pivot points that define a y-axis pivot. The bearing bias springs (175-7, 175-9) create a counterclockwise moment that biases the bearings (173-1, 173-2) against the left guide shaft (155-1) that moves up and down with the dynamic portion of the lift system (101).

The guide shaft bearing assembly including the right guide shaft (155-2) shares a similar design including the layout and the bearings (173-3, 173-4). However, several mechanical differences exist between the left and right guide shaft bearing assemblies. First, the at least one of the right bearings (173-3, 173-4) is permitted to float within the second pivot aperture (163-2) in the x-direction. Second, the bearing bias springs (175-8, 175-10) impose a clockwise moment to bias the bearings (173-3, 173-4) against the right guide shaft (155-2). During assembly, this moment ensures bearing contact with the guide shaft (155-2).

Because the y pivot axis provided by the left brace pivot pin (164-1) is also well below the build platform (151) during an alignment process, there is a long pivot arm to the top surface of the build platform (151), and the resulting motion of the build platform (151) may be considered linear in the x-direction. With the dynamic portion of the lift system (150) being permitted to pivot, the force the alignment gasket (153) places on the left and right sides of the build platform (151) center the build platform (151) within the build chamber (101). Once centered, the brace locking pins (166-1, 166-2) are engaged in order to clamp the left bearing assembly to the static portion of the lift assembly (150). With the left bearing assembly clamped, the floating right brace pivot pin (164-2) of the right bearing assembly now serves to constrain theta z-directional motion of the build platform (151), and apply a clockwise biasing force that serves to keep the left bearing system engaged with the left guide shaft (155-1).

Overtime, the clockwise biasing of the system may result in wear of the bearings (173-1, 173-2, 173-3, 173-4). Wear at the left surface will result in the platform settling in the clockwise direction, and the build platform (151) will shift to the right or positive x-direction in the build chamber (101). To account for this wear and shift, a servicing and re-alignment method may be performed. To adjust the build unit (100) to correct for wear on the bearings (173-1, 173-2, 173-3, 173-4), the following procedure may be performed. First, the build platform (151) is positioned at an alignment height within the build chamber (101). In one example, the alignment height of the build platform (151) is at the top of the build chamber (101). The brace locking pins (166-1, 166-2) are then loosened to permit the lift system (150) to pivot about the x-axis, or, in other words, in the y-direction. While the brace locking pins (166-1, 166-2) are loose, the forces from the left and right sides of the alignment gasket (153) against the build chamber (101) re-center the build platform (151) about the x-axis in the build chamber (101). The brace locking pins (166-1, 166-2) may then be tightened to re-clamp the left bearing assembly to the static portion of the lift assembly (150).

Further, in one example, there exists a cantilever compliance within the design of the build unit (100). When the build platform (151) is in the home and alignment position at the top of the build chamber (101) and near the printing surface, the guide shafts (155-1, 155-2) are fully extended. The bearings (173-1, 173-2, 173-3, 173-4) in this state have less mechanical advantage. The forces applied by the alignment gasket (153) against the build chamber (101) may cause slight deflections of the guide shafts (155-1, 155-2) and the interfaces of the bearings (173-1, 173-2, 173-3, 173-4) to provide some compliance within the build unit (100). As the build platform (151) is lowered through the build chamber (101), the bearings (173-1, 173-2, 173-3, 173-4) have more mechanical advantage to guide the lift system (150) within the build chamber (101). In the lower positions, the build platform (151) is more tightly controlled by the tight tolerance loop in the static portions of the lift system (150). In this manner, the design of the lift system (150) and its bearing assemblies provides a very good combination of positioning accuracy and compliance.

Aspects of the present system and method are described herein with reference to flowchart illustrations and/or block diagrams of methods, apparatus (systems) and computer program products according to examples of the principles described herein. Each block of the flowchart illustrations and block diagrams, and combinations of blocks in the flowchart illustrations and block diagrams, may be implemented by computer usable program code. The computer usable program code may be provided to a processor of a general-purpose computer, special purpose computer, or other programmable data processing apparatus to produce a machine, such that the computer usable program code, when executed via, for example, the processing device (201) of the 3D printing device (200) or other programmable data processing apparatus, implement the functions or acts specified in the flowchart and/or block diagram block or blocks. In one example, the computer usable program code may be embodied within a computer readable storage medium; the computer readable storage medium being part of the computer program product. In one example, the computer readable storage medium is a non-transitory computer readable medium.

The specification and figures describe a build unit. The build unit may include a build chamber, at least two datum apertures defined in at least two opposite sides of the build unit, and at least two alignment posts that seat within the datum apertures to couple the lift system to the build chamber, and to align the lift system in a first coordinate direction relative to the build chamber.

The build unit and its associated elements provide for a low-cost alignment system including several elements designed for high-volume, low cost manufacturing processes, using, for example, plastic or sheet metal. Wear in the bearings within the lift system is addressed in a simple serviceable method that re-centers the build platform through a simple loosening and tightening of clamping screws making maintenance, alignment, and realignment user-friendly for an end user. Further, the build unit uses forces provided by an alignment gasket on the build platform to center and align the build platform and the other elements within the build unit. Thus, alignment may be achieved without the use of precision tooling or gauges. Still further, long pivot arms turn pivoting motion of the dynamic and static components into linear motion of the build platform near the build chamber top and printing surface. Even still further, the hybrid system is designed to provide more compliance and tracking to the build chamber walls when the build platform is near the printing surface. As the build platform lowers and the build chamber fills with a 3D printed object, the bearings gradually guide the build platform more and more as the build platform nears the well-controlled static system location.

The preceding description has been presented to illustrate and describe examples of the principles described. This description is not intended to be exhaustive or to limit these principles to any precise form disclosed. Many modifications and variations are possible in light of the above teaching.

What is claimed is:

1. A build unit, comprising:
a build chamber;
at least two datum apertures defined in at least two opposite sides of the build unit; and
at least two alignment posts that seat within the datum apertures to couple a lift system to the build chamber, and to align the lift system in a first coordinate direction relative to the build chamber.

2. The build unit of claim 1 comprising:
at least two sides of the build chamber extending below a bottom of a lowest level of a build platform, wherein the at least two datum apertures are defined in at least two opposite sides of the build chamber; and
at least one locking fastener coupling the lift system to the build chamber to lock the alignment in a first coordinate direction.

3. The build unit of claim 1, comprising:
an alignment gasket coupled to a build platform of the lift system, the alignment gasket contacting an interior of the build chamber to align the lift system relative to the build chamber as the lift system moves the build platform through the build chamber; and
at least one bearing to align the lift system in a second coordinate direction relative to the build chamber.

4. The build unit of claim 2, comprising at least one guiding slot defined in the sides of the build chamber,
wherein the datum apertures defined within the sides of the build chamber are a terminal of the guiding slots, and
wherein the datum apertures are dimensioned to seat the alignment posts such that the alignment posts cannot move within the datum apertures.

5. The build unit of claim 1, comprising:
a motor;
a set of gears rotatably coupled to the motor; and
a screw driveshaft rotatably coupled to the gears,
wherein activation of the motor causes the gears to rotate the screw driveshaft to move a build platform coupled to the guide shafts in a third coordinate direction.

6. A three-dimensional (3D) printing device, comprising:
a build chamber comprising:
at least two sides extending below a bottom of a lowest level of a moveable build platform; and
at least two mounting points defined in at least two opposite sides of the build chamber;
a lift system comprising:
at least two alignment posts coupled to the lift system that seat within the mounting points to align the lift system in a first coordinate direction relative to the build chamber.

7. The 3D printing device of claim 6, wherein the mounting points comprise:
at least one guiding slot defined in the sides of the build chamber; and
a number of datum apertures defined within the sides of the build chamber as a terminal of the guiding slot.

8. The 3D printing device of claim 7, wherein the datum apertures are dimensioned to seat the alignment posts such that the alignment posts cannot move within the datum apertures.

9. The 3D printing device of claim 6, comprising at least one locking fastener to lock the lift system in an aligned orientation relative to the build chamber.

10. The 3D printing device of claim 6, comprising:
an alignment gasket coupled to a build platform of the lift system to align the lift system relative to the build chamber as the lift system moves the build platform through the build chamber; and
at least one guide shaft bearing assembly coupled to at least one bracket of the lift system and at least one guide shaft via at least one bearing to align the lift system in a second coordinate direction relative to the build chamber in response to the alignment gasket aligning the build platform as the build platform moves through the build chamber.

11. A method of aligning a build unit, comprising:
coupling a lift system to a build chamber using at least one alignment post coupled to the lift system that seat within a corresponding number of datum apertures defined in at least two opposite sides of the build chamber, the coupling of the lift system to the build chamber aligning the lift system in a first coordinate direction relative to the build chamber; and
aligning the lift system in a second coordinate direction relative to the build chamber using at least one guide shaft bearing assembly coupled to at least one bracket of the lift system.

12. The method of claim 11, wherein an alignment gasket coupled to a build platform of the lift system aligns the lift system relative to the build chamber as the lift system moves the build platform through the build chamber.

13. The method of claim 11, comprising locking an alignment in the first coordinate direction using at least one locking fastener coupling the lift system to the build chamber.

14. The method of claim 11, wherein the guide shaft bearing assembly comprises:
a first guide shaft bearing assembly coupled to a first guide shaft, the first guide shaft assembly being anchored to the bracket; and
a second guide shaft assembly coupled to a second guide shaft, the second guide shaft assembly being floatingly coupled to the bracket to allow for the second guide shaft assembly to float in the first coordinate direction.

15. The method of claim 11, comprising realigning the lift system, comprising:
positioning a build platform of the lift system to an alignment height;
unfastening at least one clamping fastener of a first guide shaft bearing assembly to permit the lift system to pivot;
with an alignment gasket coupled to the build platform of the lift system, aligning the lift system relative to the build chamber; and
fastening the clamping fasteners of the first guide shaft bearing assembly to statically couple the first guide shaft bearing assembly to the lift system.
